(19) United States
(12) Patent Application Publication
(10) Pub. No.: US 2008/0184529 A1
(43) Pub. Date: Aug. 7, 2008

(54) HINGE DEVICE WITH SAFETY RELEASE

(75) Inventor: Terry Thom, Spokane Valley, WA (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Itronix Corporation, Spokane Valley, WA (US)

(21) Appl. No.: 11/671,338

(22) Filed: Feb. 5, 2007

(51) Int. Cl. E05D 11/10; E05D 11/08

(52) U.S. Cl. 16/337; 16/319

(57) ABSTRACT

An apparatus may include a hinge, a positioning device, and a first component coupleable to the positioning device. The apparatus may further include a second component coupleable to the hinge, and a hinge shaft coupleable to and rotatable about the hinge, wherein manipulation of the positioning device is adapted to selectively move the first component toward the second component in a first direction to increase a level of rotational torque required to rotate the hinge shaft.

### FIELD OF THE INVENTION

The present invention generally relates to a hinge device. More specifically, the present invention relates to a hinge device with a safety release for portable devices.

### BACKGROUND OF THE INVENTION

One reasons for the popularity of portable devices, such as laptop computers, is their ability to be transported to remote locations for obtaining and processing information. These devices are usually designed in a clamshell configuration where a display screen hinges to cover a keyboard, thereby protecting both components when not in use. FIG. 1 illustrates conventional a laptop computer 100 with a display screen that is rotatable about a hinge.

In some instances, users may desire to transport their portable devices in an environment where the portable devices experience various movements, such as vibrations, shaking, oscillations, combinations thereof, and/or other types of motion. In these types of environments, a display screen of the portable device may undesirably rotate about a hinge to a new position or may even shut. For example, if a laptop computer with a hinged display screen is positioned within a vehicle, bumps, turns, and other driving conditions may cause vibrations and other forces that can cause the display screen to shut or rotate to a new position. This may require the user to reposition the display screen to regain viewability.

### SUMMARY OF THE INVENTION

An apparatus according to an exemplary embodiment may include a frame, a positioning device coupleable to the frame, a first component coupleable to the frame, a second component coupleable to the frame, and a hinge shaft coupleable to and rotatable about the frame, wherein manipulation of the positioning device is adapted to selectively move the first component toward the second component in a first direction to increase a level of rotational torque required to rotate the hinge shaft about the frame.

A system according to an exemplary embodiment may include a first section, a second section, and a hinge, the first section being rotatable about the hinge relative to the second section, the hinge may include a frame, a positioning device coupleable to the frame, a first component coupleable to the frame, a second component coupleable to the frame, and a hinge shaft coupleable to and rotatable about the frame, wherein manipulation of the positioning device is adapted to selectively move the first component toward the second component in a first direction to increase a level of rotational torque required to rotate the hinge shaft about the frame.

A method of forming a hinge assembly according to an exemplary embodiment may include attaching a frame to at least one part of a two part device that is rotatable interconnected via the hinge assembly, coupling a positioning device to the frame, coupling a hinge shaft to the frame, coupling a first component to the frame, coupling a second component to the frame, wherein the positioning device is adapted to increase a level of torque required to rotate the hinge shaft by selectively bringing the first component toward the second component.

An apparatus according to an exemplary embodiment may include a hinge, a positioning device, a first component coupleable to the positioning device, a second component coupleable to the hinge, and a hinge shaft coupleable to and rotatable about the hinge, wherein manipulation of the positioning device is adapted to selectively move the first component toward the second component in a first direction to increase a level of rotational torque required to rotate the hinge shaft.

These and other features and advantages of the present invention will be apparent from the description of exemplary embodiments provided herein.

### BRIEF DESCRIPTION OF THE DRAWINGS

Purposes and advantages of the exemplary embodiments will be apparent to those of ordinary skill in the art from the following detailed description in conjunction with the appended drawings in which like reference characters are used to indicate like elements, and in which:

FIG. 1 illustrates a conventional portable device;

FIG. 2 illustrates an exemplary embodiment of a portable device including a hinge device;

FIGS. 3A-E illustrate perspective and exploded views of an exemplary hinge device according to at least one embodiment of the invention;

FIG. 4 illustrates a top view, a side view, an end view, and a perspective view of an exemplary frame of a hinge device according to at least one embodiment of the invention;

FIG. 5 illustrates a top view, an end view, a side view, and a perspective view of an exemplary positioning device of a hinge device according to at least one embodiment of the invention;

FIG. 6 illustrates a top view, a side view, an end view, and a perspective view of an exemplary first component of a hinge device according to at least one embodiment of the invention;

FIG. 7 illustrates a top view, a side view, an end view, and a perspective view of an exemplary second component of a hinge device according to at least one embodiment of the invention;

FIG. 8 illustrates an exemplary hinge frame of a hinge device according to at least one embodiment of the invention;

FIGS. 9A-B illustrate an exemplary positioning device of a hinge device in a first position according to at least one embodiment of the invention;

FIGS. 10A-B illustrate an exemplary positioning device of a hinge device in a second position according to at least one embodiment of the invention;

FIG. 11 illustrates an exemplary interaction between a positioning device, a first component, and a second component of a hinge device according to at least one embodiment of the invention;

FIG. 12 illustrates an alternative exemplary interaction between a positioning device, a first component, and a second component of a hinge device according to at least one embodiment of the invention; and

FIGS. 13A-13B illustrate various views of an exemplary hinge device including a band clamp according to at least one embodiment of the invention.

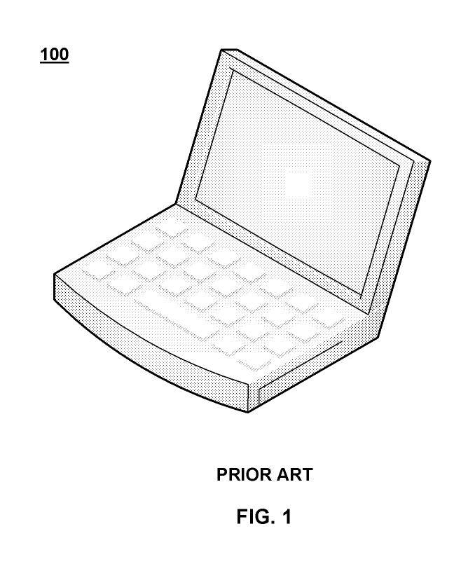

These and other embodiments and advantages will become apparent from the following detailed description, taken in conjunction with the accompanying drawings, illustrating by way of example the principles of the various exemplary embodiments.

### DETAILED DESCRIPTION OF EXEMPLARY EMBODIMENTS

The following description is intended to convey a thorough understanding of the exemplary embodiments described by providing a number of specific exemplary embodiments and details involving a hinge device with safety release for portable devices, such as portable electronic devices. It should be appreciated, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

The terminology used herein is for the purpose of describing particular embodiments only and is not intended to limit the scope of the present invention. As used throughout this disclosure, the singular forms “a,” “an,” and “the” include plural reference unless the context clearly dictates otherwise. Thus, for example, a reference to “a hinge device” includes a plurality of such hinge devices, as well as a single hinge device, and also is a reference to one or more hinge devices and equivalents thereof known to those skilled in the art, and so forth.

Unless defined otherwise, all technical and scientific terms used herein have the same meanings as commonly understood by one of ordinary skill in the art to which this invention belongs.

A need has been identified for a hinge device with a safety release that is useable with devices including portable device or portable electronic devices. For example, in a vehicular application in particular, the hinge device may be useable to reduce an operator's interaction with a display screen of the portable device.

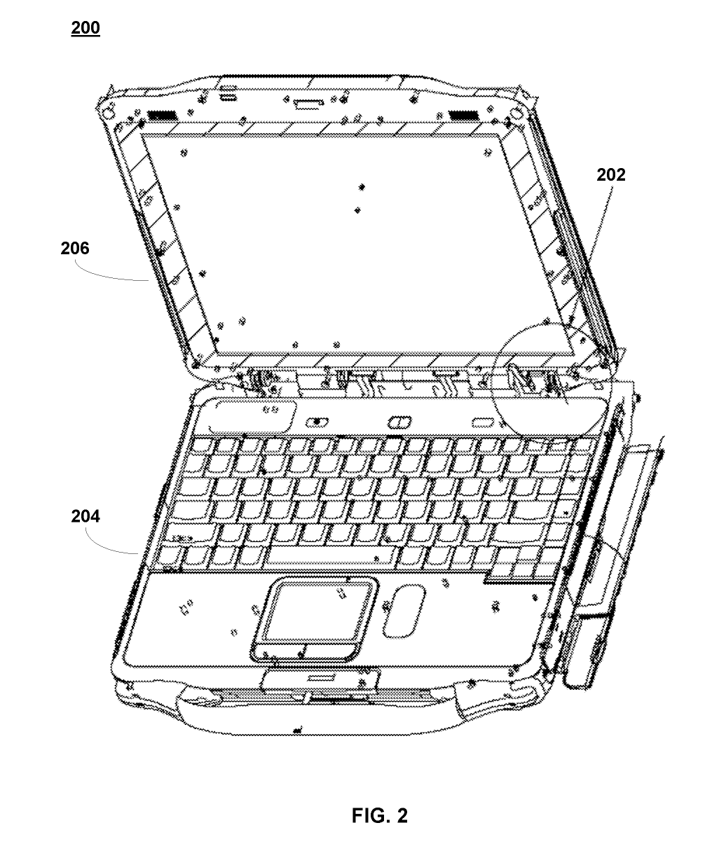

FIG. 2 illustrates an exemplary embodiment of a hinge device 202 incorporated into a portable device 200. The hinge device 202 may be used to increase an amount of rotational torque required to rotate a base 204 of the portable device 200 relative to a display 206, and hence may prevent and/or reduce unwanted movement of the display 206 relative to the base 204. The portable device 200 may include a single hinge device 202, as shown, or, may incorporate two or more hinge devices 202. The portable device 200 may be a laptop computer, a notebook computer, a cellular phone, a portable music player, or other types of portable electronic and non-electronic devices. The hinge device 202 also may be used in hinges for car hoods, awnings, toolboxes, or any other device that includes a hinge. Generally, the portable device 200 may be any device including a hinge about which two sections rotate.

In the exemplary embodiment depicted in FIG. 2, the portable device 200 is a laptop computer, where a base 204 including the keyboard may be rotated relative to a display 206 about a hinge included in the hinge device 202. In various alternative embodiments, the portable device 200 may not be portable and instead may be substantially stationary.

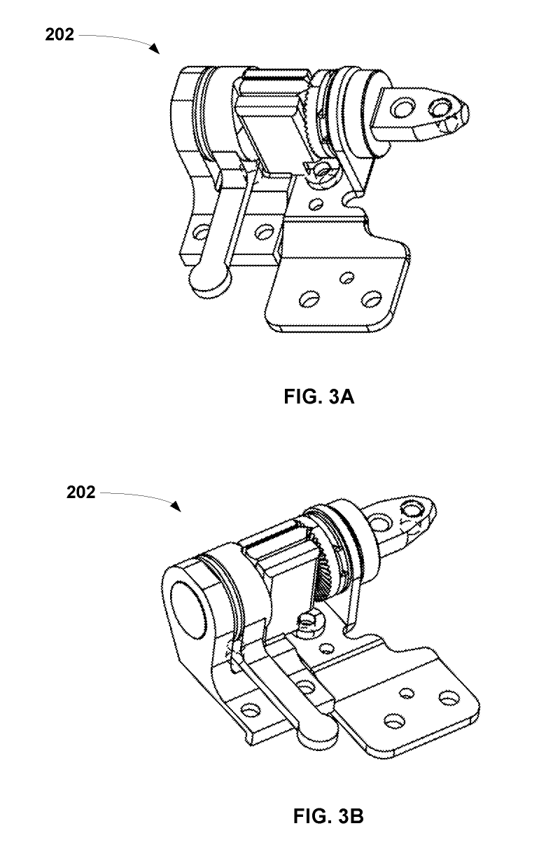

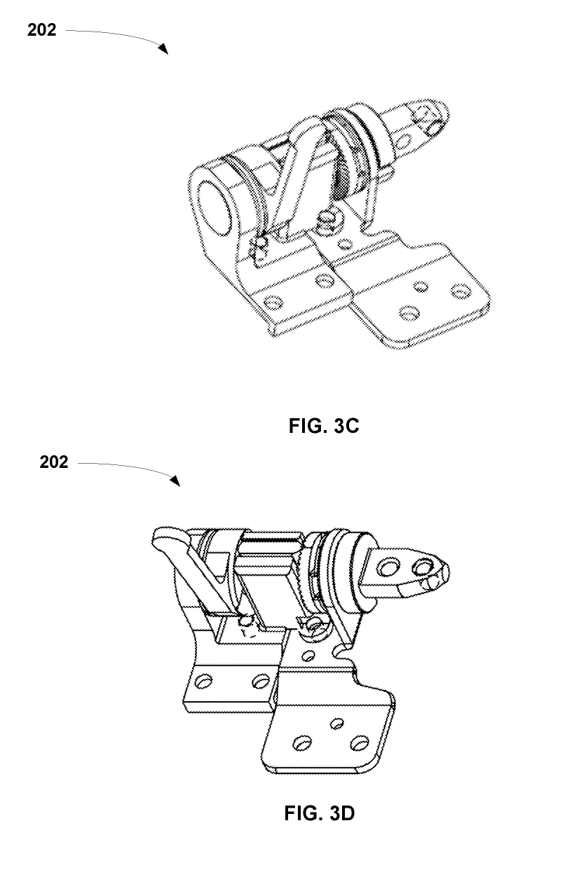

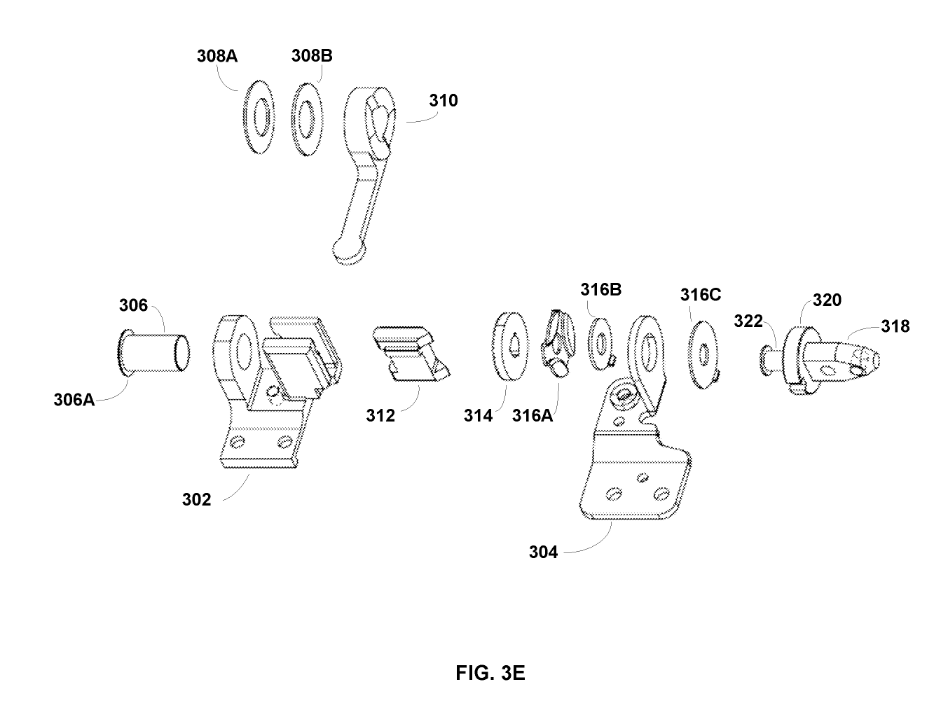

FIGS. 3A-E illustrate various exemplary embodiments of the hinge device 202. FIGS. 3A-B illustrate exemplary perspective views of the hinge device 202 having a positioning device in a first position, FIGS. 3C-D illustrate exemplary perspective views of the hinge device 202 with the positioning device in a second position, and FIG. 3E illustrates an exemplary exploded view of the hinge device 202. The following refers to FIGS. 3A-E.

The exploded view in FIG. 3E depicts the hinge device 202 including a frame 302, a hinge frame 304, a pin 306 having a lip 306A, one or more compressible devices 308A-B, a positioning device 310, a first component 312, a second component 314, one or more friction devices 316A-C, and/or a hinge shaft 318. In various alternative embodiments, the compressible devices 308A-B and the friction devices 316A-C may be omitted. Each of the devices in the hinge device 202 may be composed of, but are not limited to, metal, plastic, rubber, other durable materials, and/or combinations thereof. The compressible devices 308A-B also may be composed of rubber, silicone, or other suitable compressible materials.

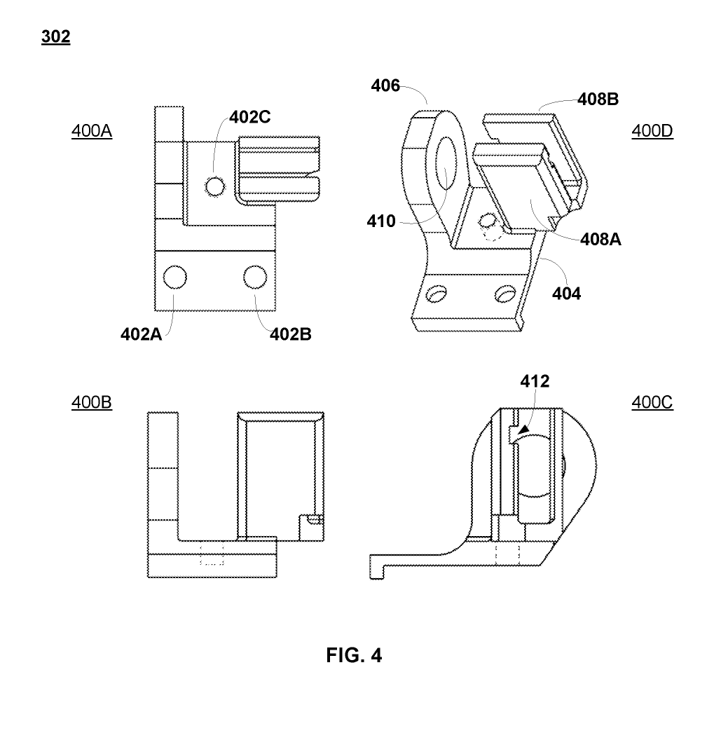

FIG. 4 further depicts an exemplary embodiment of the frame 302. A top view 400A, a side view 400B, an end view 400C, and a perspective view 400D are depicted. The frame 302 may be a single component or may include multiple parts. In various exemplary embodiments, the frame 302 is attached to the portable device 200 using a mechanical fastener, such as a screw, bolt, rivet, etc., or other suitable fastener. In various alternative embodiments, the frame 302 may be integrated into the housing of the portable device 200. The frame 302 is a housing that couples together the pin 306, the positioning device 310, the first component 312, and the one of more compressible devices 308A-B.

In various exemplary embodiments, the frame 302 includes one or more holes 402A-C, a base 404, a first projection 406, a second projection 408A, and a third projection 408B. The base 404 includes a surface that is positionable substantially adjacent to the portable device 200. Once positioned on the portable device 200, one or more mechanical fasteners, such as screws, bolts, pins, etc., are inserted through the holes 402A-C to attach the frame to the portable device 200. Alternatively, or in combination, the frame 302 also may be attached adhesively or by other means of attaching the frame 302 to the portable device 200.

Each of the first projection 406, the second projection 408A, and the third projection 408B of the frame 302 may extend outward from the base 404. As depicted in FIG. 4, the first projection 406, the second projection 408A, and the third projection 408B extend substantially perpendicular from the base 404. Other non-perpendicular projections and/or combinations of perpendicular and non-perpendicular projections also may be used. The first projection 406 includes a hole 410 formed therein for receiving the pin 306 (see also FIG. 3E). The second projection 408A and the third projection 408B may be substantially parallel to form a path for receiving and guiding the first component 312 along a linear motion axis. The second projection 408A includes a groove 412 for guiding movement of the first component 312 along the linear axis. In various alternative exemplary embodiments, the second projection 408A and the third projection 408B may be a single projection having a bore or opening formed therethrough for receiving and guiding the first component 312 for motion along a linear motion axis. Other modifications to the frame 302 also may be made.

The pin 306 may be a shaft that may be inserted through the hole 410 for coupling the one or more compressible devices 308A-B and the positioning device 310 to the frame 302 (see also FIG. 3E). The pin 306 may be inserted into the hole 410 of the first projection 406 of the frame 302. The pin 306 may include a lip 306A to prevent the pin 306 from being inserted completely through the hole 410. On the opposite side of first projection 406 from the lip 306A, the one or more compressible devices 308A-B may be attached to the pin 306 through holes formed in the compressible devices 308A-B, and the positioning device 310 may be positioned on the pin 306 after the one or more compressible devices 308A-B. Thus, the one or more compressible devices 308A-B may be positioned on the pin 306 between the first projection 406 and the positioning device 310. In various exemplary embodiments, the compressible devices 308A-B are Belleville washers. In various exemplary alternative embodiments, the compressible devices 308A-B may be coil springs, leaf springs, rubber, other suitable compressible materials, and/or combinations thereof. In various further alternative embodiments, the hinge device 202 may not include the compressible devices 308A-B, and instead the frame 302 itself may be compressible. For example, the frame 302 and/or the hinge device 202 may be composed of a flexible material or flex by design such as a cantilever arm. In a further example, ends 604A-B of the first component 312 may be composed of compressible rubber, such as, but not limited to, thermoplastic elastomer (TPE), or Thermoplastic Urethane (TPU), that flexes instead of or in addition to including the compressible devices 308A-B. The compressible devices 308A-B also may be used to provide a spring force that biases the first component 312 toward and/or against the second component 314 and, as is discussed in greater detail below, may allow for emergency release. The compression of the compressible devices 308A-B may occur through action of the positioning device 310.

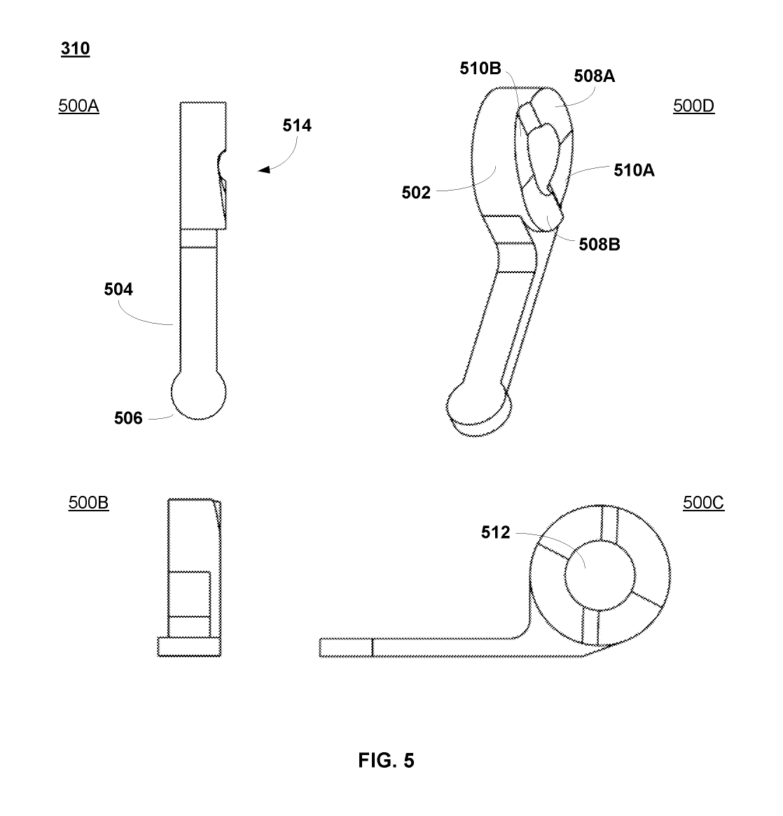

FIG. 5 includes a top view 500A, an end view 500B, a side view 500C, and a perspective view 500D of an exemplary positioning device 310. The positioning device 310 may be a lever, cam lever, wedge, air bladder, combinations thereof, and/or other device capable of moving the first component 312 a predetermined distance in a linear direction due to rotation of the positioning device 310. The movement in the linear direction may be along the axis of rotation for the positioning device 310.

The positioning device 310 includes a cylindrical portion 502 and an extension portion 504. The extension portion 504 may substantially extend linearly along a tangent to a cylindrical outer surface of the cylindrical portion 502. The extension portion 504 also may be non-linear and other symmetrical and/or non-symmetrical shapes. The extension portion 502 includes an end 506 that is rounded for receiving a finger of an operator. The end 506 also may be of other non-rounded shapes and other symmetrical and asymmetrical geometries. The end 506 and the extension portion 504 are useable by an operator to rotate the positioning device 310 about the pin 306. The positioning device 310 also includes a hole 512 formed through the cylindrical portion 502 for receiving the pin 306.

The positioning device 310 may include two different profiles on a side 514 of the cylindrical portion 502. The first profile may include surfaces 508A-B. The surfaces 508A-B may be substantially flat and may lie substantially within the same plane. The second profile may include recesses 510A-B. The recesses 510A-B may be positioned between surfaces 508A-B such that each of the recesses 510A-B may slope inward toward the interior of the cylindrical portion 502 relative to the plane in which surfaces 508A-B lie. The positioning device 310 may be used to engage and move the first component 312 in a linear direction toward and away from the second component 314.

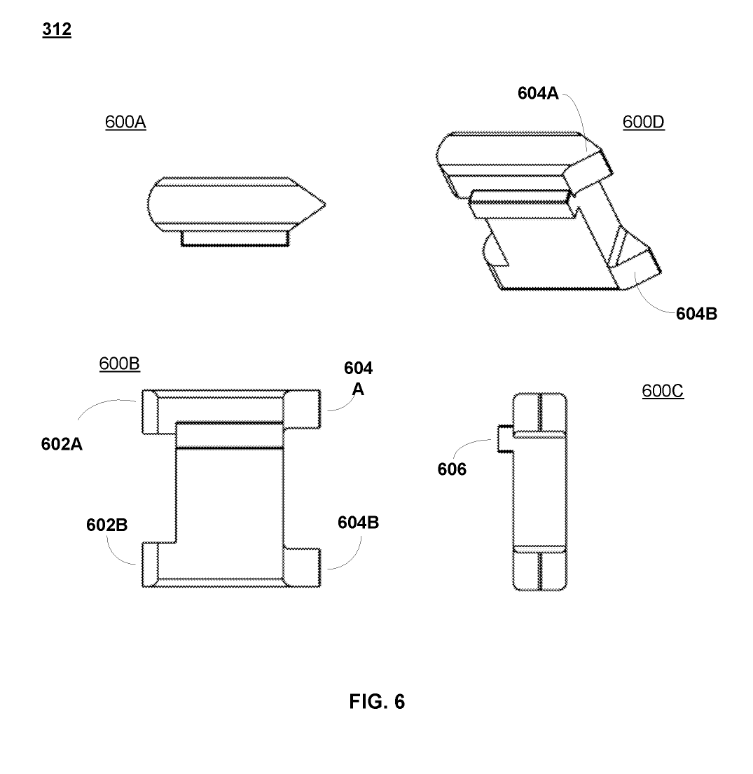

FIG. 6 illustrates a top view 600A, a side view 600B, an end view 600C, and a perspective view 600D of an exemplary first component 312. The first component 312 may be a device or object of any shape that is moveable toward the second component 314 to increase a required amount of rotational torque necessary to rotate the hinge shaft 318, as will be discussed below. In the depicted exemplary embodiment, the first component 312 is an actuator that includes a rail 606 positioned on one side. The rail 606 may fit within the groove 412 of the second projection 408A for guiding the first component 312 in linear motion along the linear motion axis (see also FIG. 4). The first component 312 may also include more that one rail 606 and more than one corresponding groove in either the second and third projections 408A-B, or both. Also, the rail 606 may be omitted from the first component 312.

The first component 312 may include an engagement projection 602 having surfaces that may engage the positioning device 310 at the surfaces 508A-B and the walls of the recesses 510A-B. As depicted in the top view 600A, the surfaces of the engagement projection 602 are rounded. The engagement projection 602 also may be shaped as a triangular prism, frustum, polyhedron, and/or other suitable geometric shapes. The shape of the engagement projection 602 also may be asymmetric, symmetric, and/or various combinations of shapes and sizes. Two engagement projections 602A-B are depicted in FIG. 6; however, the engagement projection 602 may be a single projection that extends along a side of the first component 312, may include two projections as depicted, or may include more than two projections. The engagement projection 602 also may be omitted and an entire side of the first component 312 may directly engage the positioning device 310.

On the opposite side from the engagement projection 602, the first component 312 includes a plate engagement projection 604 for engaging the second component 314. As depicted, the plate engagement projection 604 is shaped as a triangular prism. The plate engagement projection 604 may be shaped as a semi-sphere, frustum, polyhedron, and/or other suitable geometric shapes. The shape of the plate engagement projections 604A-B also may be asymmetric, symmetric, and/or various combinations of shapes and sizes. Two plate engagement projections 604A-B are depicted in FIG. 6; however, the plate engagement projection 604 may be a single projection that extends along a side of the first component 312, may include two projections as depicted, or may include more than two projections. The first component 312 may be moveable toward and/or engageable with the second component 314.

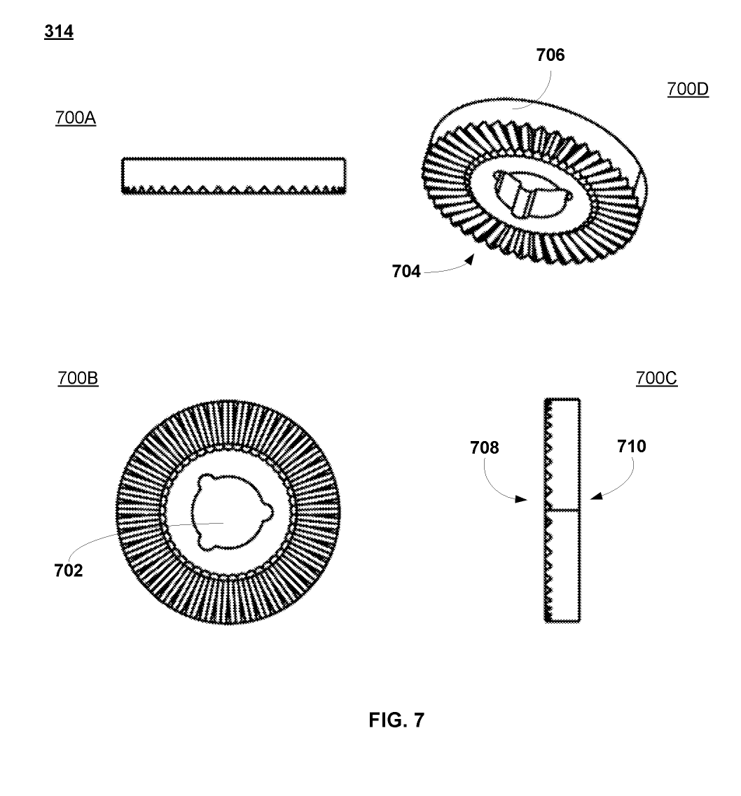

FIG. 7 further illustrates a top view 700A, a side view 700B, an end view 700C, and a perspective view 700D of an exemplary second component 314. The second component 314 may be a cylindrically shaped plate 706 and may have a hole 702 formed therethrough. The hole 702 may include indentations that may prevent rotating of the second component 314 on the shaft 322 when flange 802 is swaged over. These indentations give the material from the swaging process a place to go and create a better joint.

The second component 314 may include a first surface 708 and a second surface 710 on opposite sides of the second component 314. The second surface 710 may be substantially smooth and flat, or alternatively may be roughened or may include various features, such as, but not limited to, notches, projections, recesses, and/or combinations thereof. The first surface 708 of the second component 314 may include a plurality of notches 704. The plurality of notches 704 may be indentations into the surface of the second component 314 for engaging the engagement projection 604 of the first component 312. The notches 704 may include recesses in the shape of triangular prisms, semi-spheres, polyhedrons, other suitable geometric shapes, symmetric shapes, asymmetric shapes, and/or combinations thereof. The notches 704 may be of a same depth or of varying depths relative to one another. In the depicted embodiment, the notches 704 are uniformly spaced apart radially. Non-uniform and/or non-radially-spaced notches also may be used. Additionally, the first surface 708 may not include the notches 704, and instead may include a textured surface, such as, but not limited to, a smooth surface, a roughened surface including varying textures, and/or combinations thereof. The first surface 708 also may include notches 704 and a textured surface.

The notches 704 of the second component 314 may engage the plate engagement projections 604A-B of the first component 312 thus forming a projection notch pair. The shape of the indentations of the notches 704 may be complementary to the shape of the plate engagement projections 604A-B. For example, if the plate engagement projections 604A-B are shaped as triangular prisms, the notches 704 will be triangular prism shaped recesses. In various exemplary alternative embodiments, the shape of the notches 704 may not correspond to the shape of the plate engagement projections 604A-B. In the various further exemplary alternative embodiments, engagement projections 604A-B may be formed on the second component 314, and the notches 704 may be formed on the first component 312. In various alternative exemplary embodiments, the plate engagement projections 604A-B may be omitted and the second component 314 may have a smooth surface without any of the notches 704.

The depth of the notches 704 into the second component 314 and the length of the projections of the plate engagement projections 604A-B may be adjusted. The size, shape, and material of the plate engagement projections 604A-B of the first component 312 and the notches 704 of the second component 314 may be used to adjust and/or control the amount of additional torque required to rotate the hinge shaft 318. For example, a greater amount of additional torque may be necessary to rotate the hinge shaft 318 for longer plate engagement projections 604 outward of the first component 312 and deeper recesses formed at the notches 704 of second component 314. A lesser amount of required torque may be necessary to rotate the hinge shaft 318 for smaller plate engagement projections 604A-B and shallower recesses formed at the notches 704.

Additionally, the amount of contact surface area of the plate engagement projections 604A-B of the first component 312 engaging the notches 704 of the second component 314 also may control the amount of additional torque required. In various exemplary embodiments, greater contact surface area increases the amount of additional torque required to rotate the hinge shaft 318, while lesser contact surface area will decrease the amount of additional torque required. Moreover, the materials of which surfaces of the plate engagement projections 604A-B of the first component 312 and the notches 704 of the second component 314 are composed may be used to control the amount of torque required. In various exemplary alternative embodiments, contact surfaces of the first component 312 and/or the walls of the notches 704 of the second component 314 may be composed of a softer material, such as rubber, TPE, Thermal Plastic Rubber (TPR), TPU, ceramic, brass, bronze, carbon fiber, etc. In general, materials that create a high friction when in contact with each other, such as, but not limited to, rubber on rubber, rubber on a porous surface, etc., may be used. Materials that wear slowly are preferred. Also, materials such as titanium may be used for the contact surfaces. Additionally, materials similar to brake pads on an automobile may be used on the plate engagement projections 604A-B the walls of the notches 704. Other materials and shapes for the first component 312 and the second component 614 also may be used. Any two materials or shapes may be used that create a desired amount of friction when receiving a normal force causing the two materials or shapes to contact one another.

In further alternative exemplary embodiments, an additional second component may be substituted for the first component 312 and movement of the positioning device 310 may move the other second component toward the second component 314. The second components may include substantially smooth surfaces, smooth and roughened surfaces, corresponding notches and projections, differing notches, projections, smooth surfaces, and roughened surfaces, and/or combinations thereof. The surfaces of the second components 314 and 314B also may be composed of rubber, or other like or differing materials to adjust the amount of torque required for rotation of the hinge shaft 318.

In still further alternative exemplary embodiments, the components within the hinge device 202 may be rearranged. For example, the second component 314 may be placed adjacent to the positioning device 310, and rotation of the positioning device 310 may be used to move the second component 314 into contact with a first component 312 that is fixedly coupled to the hinge shaft 318. Other modifications to the hinge device 202 also may be made.

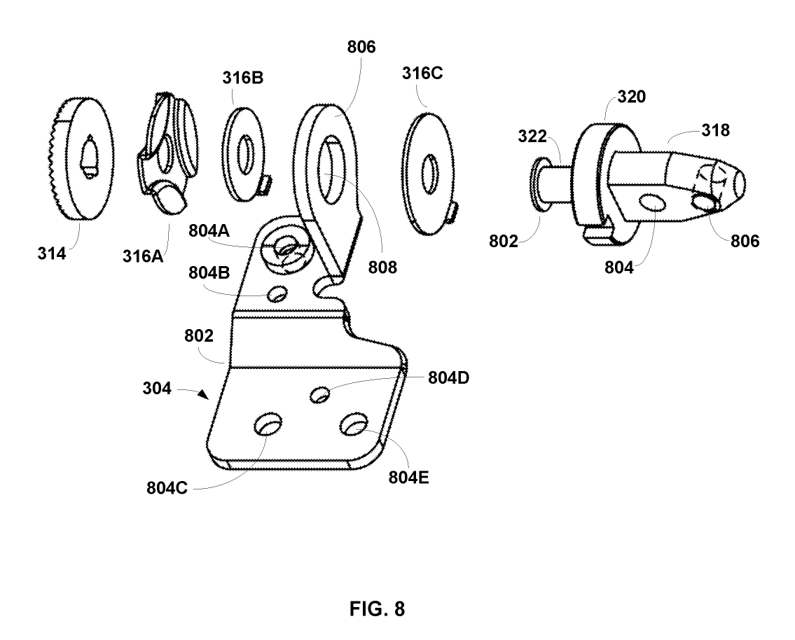

FIG. 8 illustrates an exemplary hinge frame 304 and an exemplary hinge shaft 318. The frame 302 and the hinge frame 304 also may be a single component, instead of separate components, as depicted. The hinge frame 304 may include a base 802 having one or more holes 804A-E, and a hinge frame projection 806 having a hole 808 formed therethrough. One or more mechanical fasteners, such as screws, bolts, rivets, pins, etc., may be inserted through the holes 804A-E to attach the hinge frame 304 to the portable device 200. The hinge frame 304 also may be comprised of components that are manufactured as a part of the housing of the base 204 or of the portable device 200, and/or may be attached adhesively to the portable device 200.

The hinge frame 304 may couple together the second component 314, the one or more friction devices 316A-C, and the hinge shaft 318. The second component 314 may be positioned on and fixedly or non-fixedly attached to the hinge shaft 318 at the shaft pin 322. For example, if the second component 314 is fixedly attached to the hinge shaft 318, rotation of the hinge shaft 318 over a predetermined angle also rotates the second component 314 over the predetermined angle in the same direction. If the second component 314 is non-fixedly attached, rotation of the hinge shaft 318 over a predetermined angle may not result in a corresponding rotation of the second component 314. Thus, rotation of the hinge device 318 over a predetermined angle may not cause an equivalent rotation of the second component 314 over the predetermined angle, and instead may rotate the second component 314 over a smaller or greater angle than the predetermined angled.

The shaft pin 322 may be inserted through the hole 808 of the hinge frame projection 806 to couple the shaft pin 322 with the hinge frame 304. The shaft pin 322 may rotate within the hole 808 to adjust a position of the display screen 206 relative to the base 204 of the portable device 200. The shaft pin 322 also attaches the second component 314 and the friction devices 316A-B to the hinge frame 304 between a lip 802 of the shaft pin 322 and the hinge frame projection 806. The shaft pin 322 also attaches the friction device 316C to the frame 304 between the hinge frame projection 806 and lip 320.

The friction devices 316A-C may be composed of a compressible material useable to create an increased level of rotational torque necessary to rotate the hinge shaft 318. For example, the friction device 316A may be washers. When the lip 802 is inserted, friction device 316A may be slightly compressed against the friction device 316B and the hinge frame projection 806 to create a constant pressure on friction devices 316A-C so that the hinge device 202 may substantially have a constant uniform torque. The hinge shaft 318 also may include holes 804 and 806 for attaching the hinge shaft 318 to a display 206 of the portable device 200.

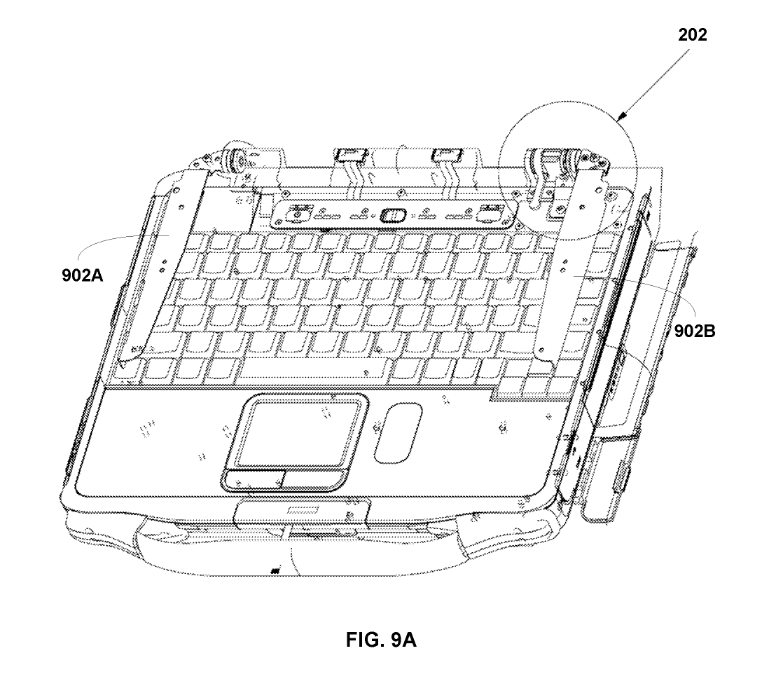

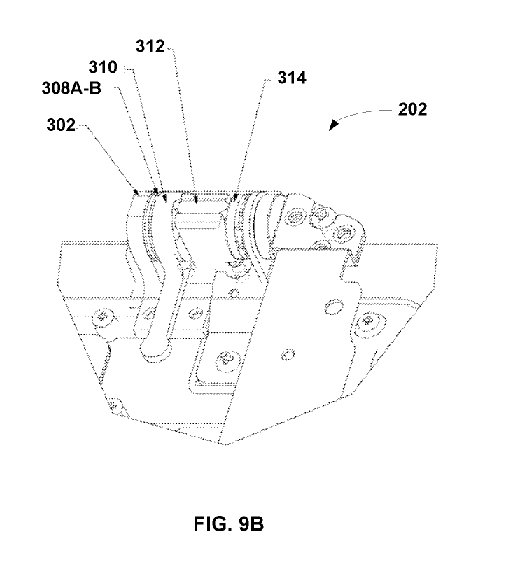

FIGS. 9A-B and 10A-B illustrate an exemplary embodiment of the portable device 200 without the display 206 to further illustrate the hinge device 202. Rails 902A-B are coupled to the holes 804 and 806 of the hinge shaft 318 using mechanical fasteners, such as screws, bolts, rivets, etc., to attach the rails 902A-B to the hinge device 202. Adhesive or other attaching means also may be used. The rails 902A-B are used to couple the display 206 to the hinge device 202.

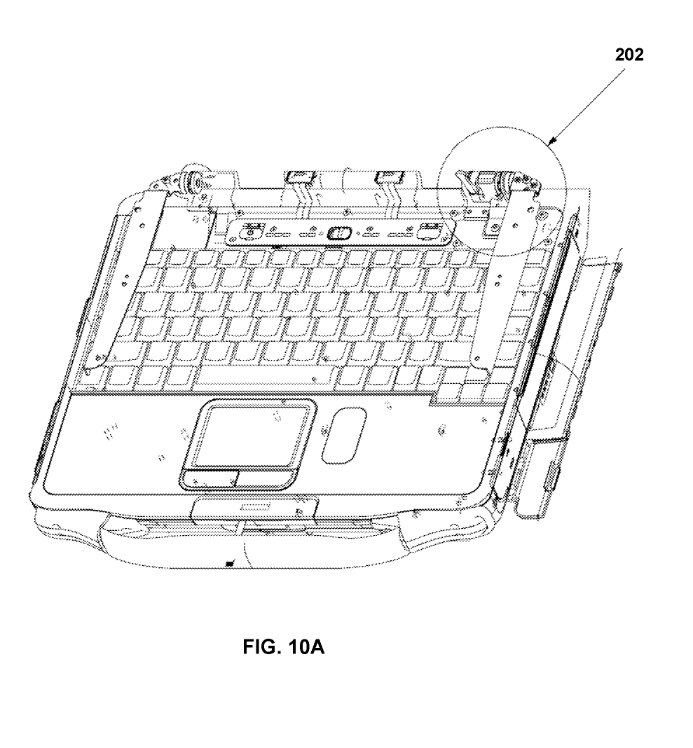

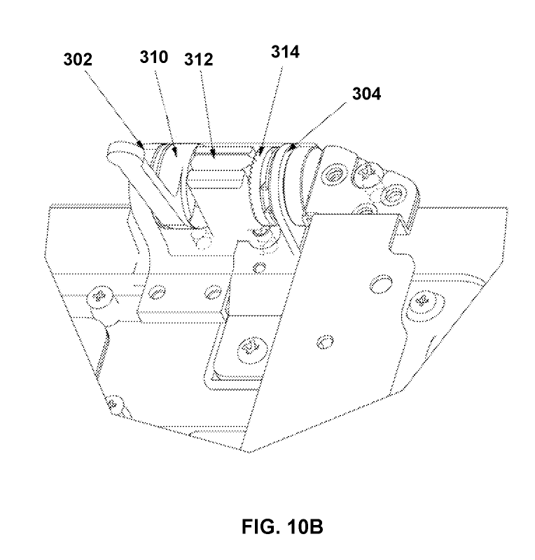

FIGS. 9A-B illustrate the positioning device 310 of the hinge device 202 in a first position, with FIG. 9A depicting the hinge device 202 attached to the base 204, and FIG. 9B depicting a detailed view of the hinge device 202. FIGS. 10A-B illustrate the positioning device 310 of the hinge device 202 in a second position, with FIG. 10A depicting the hinge device 202 attached to the base 204, and FIG. 10B depicting a detailed view of the hinge device 202. The positioning device 310 may be rotated about the pin 306 to control the amount of radial torque necessary to rotate the hinge shaft 318. When the positioning device 310 is in the first position depicted in FIGS. 9A-B, the engagement projections 602A-B of the first component 312 may be contained within the recesses 510A-B of the positioning device 310 (see also FIGS. 3E, 5, and 6). The engagement projections 602A-B of the first component 312 may be positioned within the recesses 510A-B without contacting walls of the recesses 510A-B, or alternatively may contact the walls of the recesses 510A-B.

When the positioning device 310 is in the first position depicted in FIGS. 9A-B, the torque necessary to rotate the hinge shaft 318 may be a function of the one or more friction devices 316A-C. The one or more friction devices 316A-C may interact with one another to create a desired amount of torque necessary for rotation of the hinge shaft 318 within the hole 808 of the hinge frame projection 806. Friction device 316A is compressed when the hinge device 202 is assembled and applies pressure to the other friction devices 316B-C. Friction devices 316B-C are composed of materials that provide smooth rotation of the hinge at a specified torque, such as or a. For example, the friction devices 316B-C may be composed of bronze, carbon fiber, graphite, brass, other suitable wear resistant materials, and may be lubricated with grease to facilitate smooth rotation. The friction devices 316A-C also may affect the smoothness of the rotation of the hinge shaft 318. The friction devices 316A-C may permit a smooth or non-smooth movement during rotation of the hinge shaft 318. The friction devices 316A-C also may be omitted from the hinge device 202.

To increase the amount of rotational torque necessary for rotation of the hinge shaft 318, the positioning device 310 may be rotated about the pin 306 to the second position, as depicted in FIGS. 10A-B. The additional required torque may prevent and/or reduce rotation of the hinge shaft 318 when the portable device 200 experiences vibrations, oscillations, shaking, combinations thereof, and/or any other forces that create a rotational torque that is less than or equal to the level of additional rotational torque necessary to rotate the hinge shaft 318. As the positioning device 310 rotates about the pin 306, the engagement projections 602A-B of the first component 312 transition from engaging the recesses 510A-B to engaging the surfaces 508A-B of the positioning device 310 (see also FIGS. 3E, 5, and 6). This rotation may place a normal force causing the first component 312 to move toward the second component 314 in a linear direction along an axis of rotation of the positioning device 310.

The normal force also may be created in other ways, such as, but not limited to, a wedge that is pushed or pulled, a lever that is moved side to side, an air bladder that is pumped up, etc., and/or other known mechanisms for creating a normal force. The positioning device 310 also may be replaced with a positioning device that is moveable from side to side and mechanically fastenable at one and/or both sides. A user also may rotate the positioning device 310 from the second position back to the first position to release the additional torque required for rotation of the hinge shaft 318.

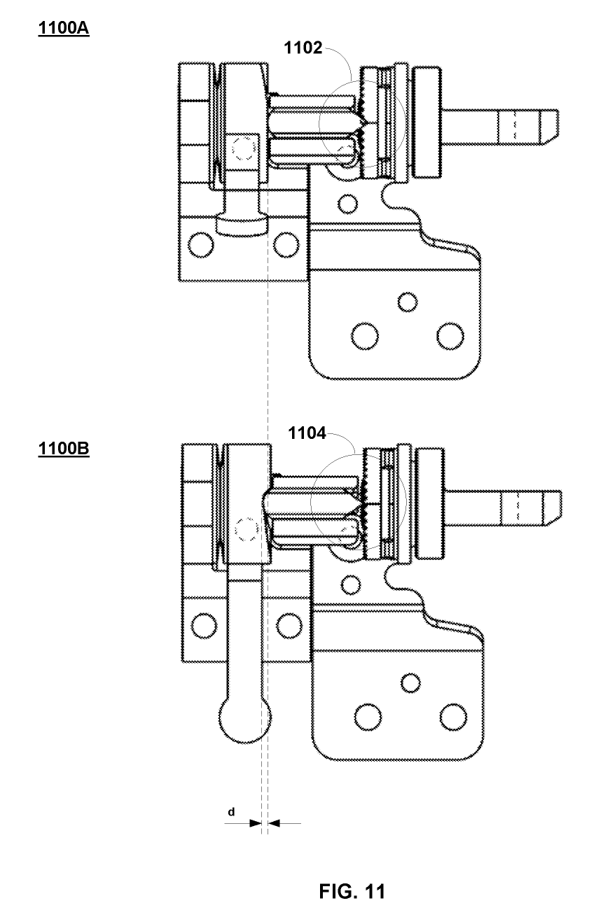

FIG. 11 depicts two top views of an exemplary embodiment of the movement of the first component 312 along a linear motion axis caused by the rotation of the positioning device 310. The lower top view 1100B depicts the positioning device 310 in the first position, and the upper top view 1100A depicts the positioning device 310 in the second position. Rotating the positioning device 310 from the first position depicted in the lower top view 1100B to the second position depicted in the upper top view 1100A causes the first component 312 to move a distance ‘d.’ In the lower top view 1100B, the hinge shaft 318 may rotate about the hole 808 of the hinge frame projection 806 without engaging or contacting the first component 312. A separation between the first component 312 and the second component 314 is depicted at 1104.

Rotation of the positioning device 310 to the second position depicted in the upper top view 1100A moves the first component 312 by a distance ‘d.’ This movement may cause the plate engagement projections 604A-B of the first component 312 to engage the second component 314 at the notches 704, as depicted at 1102. The surfaces of the plate engagement projections 604A-B may engage the surfaces of the notches 704, or alternatively, the surfaces of the plate engagement projections 604A-B may be in close proximity to the surfaces of the notches 704, and only engage the surfaces of the notches 704 when either the display 206 or the display 204 receive a force, vibration, etc., relative to one another. In a further alternative embodiment, the movement of the first component 312 by the distance ‘d’ against the second component 314 additionally may compress the one or more compressible devices 308A-B on the other side of the positioning device 310 to provide additional normal spring force to increase a rotational torque necessary for rotation of the hinge device 202.

In various further exemplary embodiments, rotation of the positioning device 310 may cause the first component 312 to move the second component 314 to compress one or more of the friction devices 316A-C against the hinge frame projection 806 of the hinge frame 304. In the exemplary embodiment depicted in FIGS. 9A-B and 10A-B, this compression of the friction devices 316A-C may increase the amount of torque required to rotate the hinge shaft 318 due to a relationship between pressure on friction devices 316A-C and the torque required to rotate the hinge. The greater the pressure on friction devices 316A-C results in a higher the torque.

Thus, friction about the hinge shaft 318 may be increased in three different ways. The first way of increasing friction involves the interaction of the first component 312 with the second component 314, the second way additionally involves the compression of one or more of the friction devices 316A-C, and the third way involves the compression of the compressible devices 308A-B. Various combinations of these ways of increasing friction may be used.

In various exemplary alternative embodiments, the positioning device 310 may include multiple levels of surfaces 508A-B to control the amount of additional torque required to rotate the hinge shaft 318. For example, the first level may move the first component 312 half of the distance ‘d’ (i.e., 0.5d), and the second level may move the first component 312 the distance ‘d.’ Two or more levels of surfaces for the positioning device 310 may be used, other fractions of distance ‘d’ may be used, and/or combinations thereof may be used.

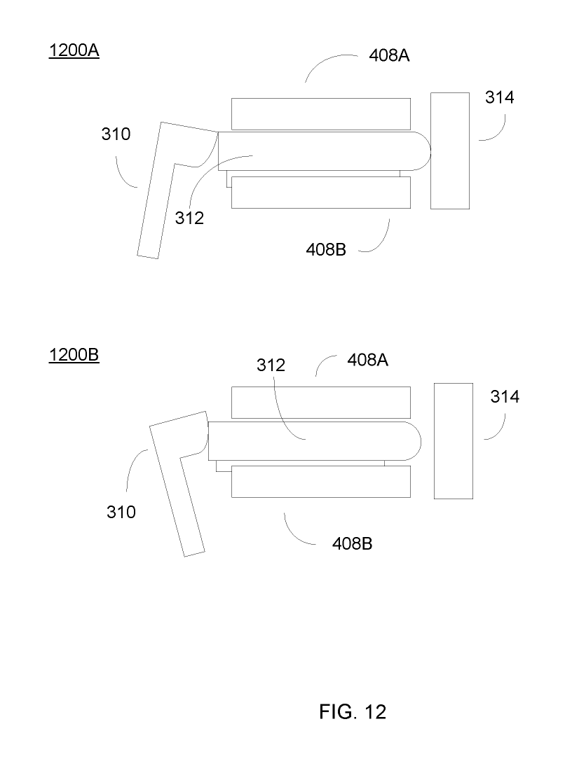

FIG. 12 illustrates another exemplary embodiment of the positioning device 310 moving the first component 312 into engagement with the second component 314. In the depicted embodiment, the positioning device 310 is rotatable about an axis that is perpendicular to a linear motion axis of the first component 312. The first component 312 includes a rounded end for selectively engaging a flat surface of the second component 314. The first component 312 also may include a projection that is positionable within a notch of the second component 314 and that may or may not contact a wall of the notch of the second component 314. Other configurations of notches, projections, flat surfaces, curved surfaces, combinations thereof, and/or other surfaces disclosed herein, for the first component 312 and second component 314 also may be used.

As the positioning device 310 rotates clockwise from the view depicted in 1200B to the view depicted in 1200A, the curved surface of the positioning device 310 may move the first component 312 toward the second component 314 until the first component 312 contacts the second component 314. This movement of the first component 314 also may, in a further alternative exemplary embodiment, be used to compress the friction devices 316A-C and/or the compressible devices 308A-B. A latch or other mechanical device (not shown) may be used to secure the positioning device 310 in the position depicted in 1200A and the position depicted in 1200B. A spring or other separating device (not shown) may be associated with the first component 312 to separate the first component 312 from the second component 314 in the position depicted in 1200B.

The hinge device 202 also may provide various safety features. In various exemplary embodiments, the portable device 200 may be placed on a docking station within a vehicle, such as, but not limited to, an automobile. A user may place the portable device 200 on the docking station such that the user may view the display 206 while driving the vehicle. The docking station may be a stand, or other device for positioning and maintaining the portable device 200 at a substantially fixed location. Alternatively, a docking station may not be used.

In the event of airbag deployment, the hinge device 202 may provide a safety release for the positioning device 310. For example, if a force is applied to the display 206 or the base 204 that creates a rotational torque is greater than the level of increased rotational torque required to rotate the hinge shaft 318, the compressible devices 308A-B may be permitted to compress thereby allowing the hinge device 202 to disengage the first component 312 from the second component 314. In various exemplary embodiments, the compression of the compressible devices 308A-B may permit the display 206 to rotate about the hinge 202 toward the base 204. Compressing the compressible devices 308A-B may allow a separation between the first component 312 and the second component 314 to permit the first component 312 to ratchet between notches 704 of the second component 314. In other words, compression of the compressible devices 308A-B may permit the plate engagement projections 604A-B of the first component 312 to change from engaging a first set of one or more notches 704 to engaging a second set of one or more notches 704. The second set of notches 704 may be immediately adjacent to the first set of notches 704, or may be spaced away from another by one or more sets of notches 704 depending on the size, direction, and duration of the force.

To accomplish this safety release, as the display 206 rotates over a predetermined angle under the stress of the applied force, and contacts the surface of end 506 thus rotating the positioning device 310 to the down position, the engagement projections 602A-B of the first component 312 may transition from contacting the surfaces 508A-B of the positioning device 310 to contacting (and/or being positioned within) the recesses 510A-B of the positioning device 310, thereby moving the first component 312 back a distance ‘d’ to the first position. This disengages the first component 312 from the second component 314 and thereby removes the additional torque required for rotation of the hinge shaft 318. Thus, the hinge device 202 ratchets a predetermined number of times and then disengages the first component 312 from the second component 314 to release the additional torque necessary for rotation of the hinge shaft 318. In an alternative exemplary embodiment, the hinge device 202 may rotate over a predetermined angle due to the force and then disengage the first component 312 from the second component 314. This safety feature also may be used when the user forgets to rotate the positioning device 310 to the first position before closing the display 206 and forcibly closes the display 206. This safety release prevents a user from having to overcome the increased amount of rotational torque to open the display 206 caused by the first component 312 engaging the second component 314.

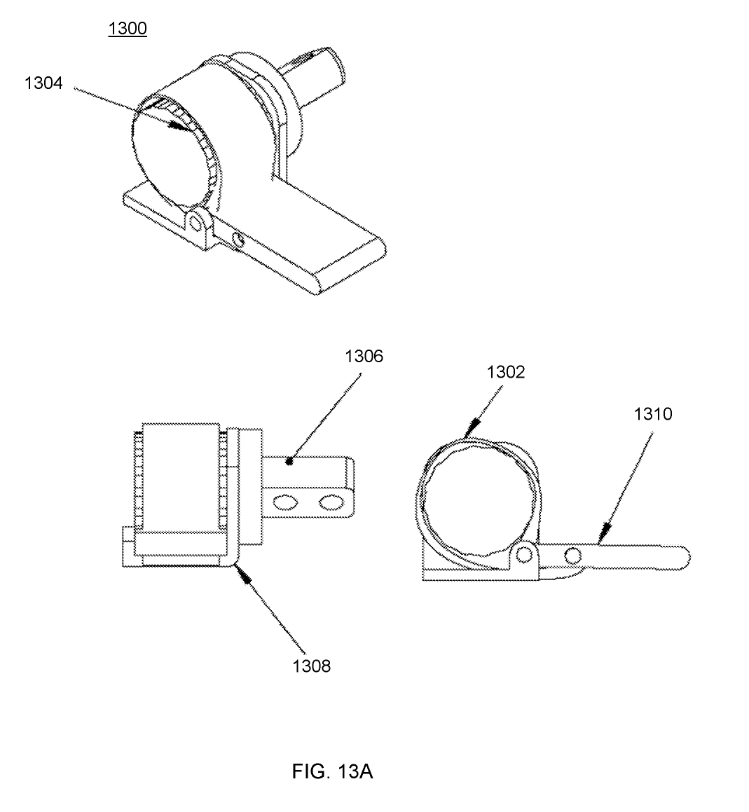

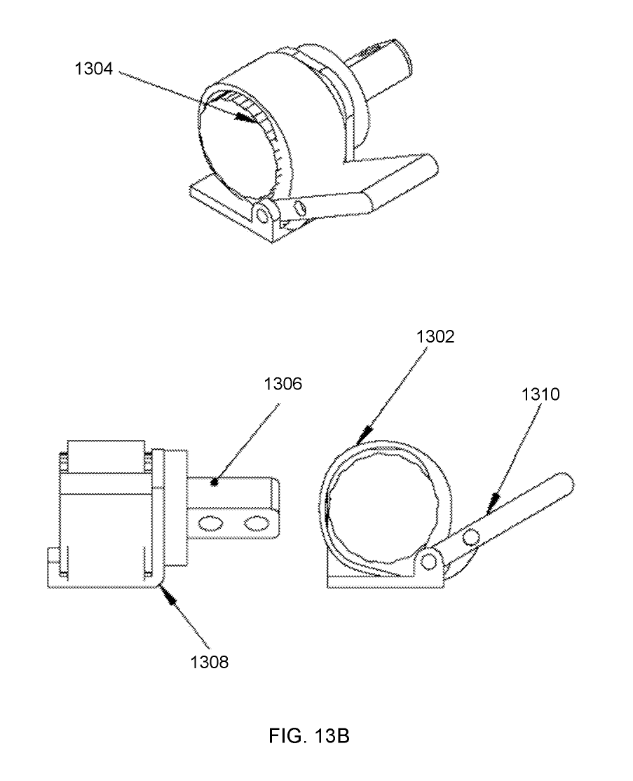

FIGS. 13A-B illustrate various views of another exemplary hinge device 1300 including a band clamp 1302, according to an exemplary embodiment of the present invention. FIGS. 13A-B each depict a perspective view, a side view, and an end view of the hinge device 1300. The hinge device 1300 may include a shaft 1306 that may rotate within frame 1308. A band clamp 1302 may be positioned around an outer surface 1304 of the shaft 1306. The band clamp 1302 may be composed of a flexible material, such as, but not limited to, plastic, thin steel, fabric (e.g., nylon), etc. An inner surface of the band clamp 1302 also may be smooth or textured. The outer surface 1304 of the shaft 1306 may include a friction feature, such as being smooth surface, may have bumps thereon, or may have other features to help increase the friction when contacting the band clamp 1302.

The hinge device 1300 may include a positioning device 1310 for adjusting a tightness of the band clamp 1302 about the shaft 1306. The tightness of the band clamp 1306 about the shaft 1306 may adjust the amount of torque required to rotate the shaft 1306 within the frame 1308. When the positioning device 1310 is in the lower position (see FIG. 13A), the shaft 1306 may rotate without the band clamp 1302 substantially contacting outer surface 1304 of the shaft 1306 or substantially frictionally engaging the shaft 1306. When the positioning device 1310 is rotated to the upper position (see FIG. 13A), the band clamp 1302 may tighten about the shaft 1306 and may frictionally engage the outer surface 1304 of the shaft 1306. The contact of the outer surface 1304 frictionally engaging the shaft 1306 increases the amount of torque required for rotation of the shaft 1306 within the frame 1308. From the upper position, the positioning device 1310 may be rotated to the lower position (see FIG. 13A) to release the frictional engagement and to release the increased about of rotational torque required to rotate the shaft 1306. Similarly as discussed above, a portable device 200 incorporating the hinge device 1300 may have the safety feature that closing the display 206 may move the positioning device 1310 to the lower position and may release the frictional engagement. Thus, a band clamp 1302 also may be used to control the amount of torque required to rotate the shaft 1306 to provide increased stability and to prevent unwanted movement.

Therefore, the various exemplary embodiments disclose a hinge device that may selectively be used to increase the amount of rotational torque required to rotate a hinge. The additional rotational torque provided by the hinge device may be used to prevent unwanted rotation of the hinge shaft. In various exemplary embodiments, the hinge device may be used on a portable device, such as, but not limited to, a laptop computer, to prevent the display from rotating about a hinge to a new position while driving or in other environments that may vibrate, oscillate, shake, combinations thereof, and/or other movements that may cause the display to rotate about a hinge. The hinge device also may be used in other devices, such as, but not limited to, car hoods, awnings, toolboxes, and/or any other device including a hinge, to increase the amount of rotational torque necessary for rotating the hinge.

The exemplary embodiments of the present invention are not to be limited in scope by the specific embodiments described herein. For example, although many of the embodiments disclosed herein have been described with reference to systems and methods for a hinge device for use with a portable device, such as, but not limited to, a laptop computer, the principles herein are equally applicable to other devices having a hinge where it is desirable to increase the rotational torque required to prevent unwanted rotation about the hinge. Indeed, various modifications of the embodiments of the present inventions, in addition to those described herein, will be apparent to those of ordinary skill in the art from the foregoing description and accompanying drawings. Thus, such modifications are intended to fall within the scope of the following appended claims. Further, although some of the embodiments of the present invention have been described herein in the context of a particular implementation in a particular environment for a particular purpose, those of ordinary skill in the art will recognize that its usefulness is not limited thereto and that the embodiments of the present inventions can be beneficially implemented in any number of environments for any number of purposes. Accordingly, the claims set forth below should be construed in view of the full breath and spirit of the embodiments of the present inventions as disclosed herein.

1. An apparatus comprising:
a frame;
a positioning device coupleable to the frame;
a first component coupleable to the frame;
a second component coupleable to the frame; and
a hinge shaft coupleable to and rotatable about the frame, wherein manipulation of the positioning device is adapted to selectively move the first component toward the second component in a first direction to increase a level of rotational torque required to rotate the hinge shaft about the frame.

2. The apparatus of claim 1, wherein the manipulation of the positioning device selectively moves the first component into contact with the second component.

3. The apparatus of claim 1, wherein the first component comprises at least one component selected from the group consisting of an actuator and a plate, and wherein the second component comprises at least one component selected from the group consisting of an actuator and a plate.

4. The apparatus of claim 1, wherein a surface of the first component and/or the second component is composed of rubber.

5. The apparatus of claim 1, wherein the first component and the second component comprise a projection notch pair, wherein the notch is adapted to receive the projection.

6. The apparatus of claim 1, wherein manipulation of the positioning device involves rotation of the positioning device about an axis.

7. The apparatus of claim 6, wherein the axis is either co-linear with the first direction or is perpendicular to the first direction.

8. The apparatus of claim 1, wherein the increased level of rotational torque is adapted to prevent rotation of the hinge shaft when the hinge shaft receives a force creating a torque that is less than or equal to the level of rotational torque required to rotate the hinge shaft about the frame.

9. The apparatus of claim 1, wherein the first component is adapted to ratchet relative to the second component when the hinge shaft receives a force creating a torque that is greater than the level of rotational torque required to rotate the hinge shaft about the frame.

10. The apparatus of claim 9, wherein the second component further comprises:
a first notch formed on a surface; and
a second notch formed on the surface, wherein the first component ratchets from the first notch to the second notch.

11. The apparatus of claim 9, wherein ratcheting the first component relative to the second component a predetermined number of times is adapted to release the increased rotational torque.

12. The apparatus of claim 1, wherein the first component is adapted to rotate relative to the second component when the hinge shaft receives a first force creating a torque that is greater than the level of rotational torque required to rotate the hinge shaft about the frame.

13. The apparatus of claim 12, wherein the rotation of the first component relative to the second component over a predetermined angle is adapted to release the increased level of rotational torque.

14. The apparatus of claim 12, further comprising:
a compressible device adapted to apply a spring force to the first component in the first direction; and
a pin adapted to couple the compressible device and the positioning device to the frame, wherein the first force deflects the compressible device to permit the rotation of the first component relative to the second component.

15. The apparatus of claim 1, wherein the second component is fixedly coupled to the hinge shaft.

16. The apparatus of claim 1, further comprising:
a friction device coupled to the hinge shaft.

17. The apparatus of claim 16, wherein the movement of the first component is adapted to move the second component to compress the friction device, wherein compression of the friction device further increases the level of rotational torque required to rotate the hinge shaft about the frame.

18. A system comprising:
a first section;
a second section; and
a hinge, the first section being rotatable about the hinge relative to the second section, the hinge comprising:
a frame;
a positioning device coupleable to the frame;
a first component coupleable to the frame;
a second component coupleable to the frame; and
a hinge shaft coupleable to and rotatable about the frame, wherein manipulation of the positioning device is adapted to selectively move the first component toward the second component in a first direction to increase a level of rotational torque required to rotate the hinge shaft about the frame.

19. The system of claim 18, wherein the first section comprises a display and the second section comprises a keyboard.

20. A method of forming a hinge assembly comprising:
attaching a frame to at least one part of a two part device that is rotatable interconnected via the hinge assembly;
coupling a positioning device to the frame;
coupling a hinge shaft to the frame;
coupling a first component to the frame; and
coupling a second component to the frame, wherein the positioning device is adapted to increase a level of torque required to rotate the hinge shaft by selectively bringing the first component toward the second component.

21. The method of claim 20, wherein the attaching comprises adhesive and/or a mechanical fastening.

22. An apparatus comprising:
a hinge;
a positioning device;
a first component moveable by the positioning device;
a second component; and
a hinge shaft coupleable to and rotatable about the hinge, wherein manipulation of the positioning device is adapted to selectively move the first component toward the second component in a first direction to increase a level of rotational torque required to rotate the hinge shaft.
